(19) United States
(12) Patent Application Publication
(10) Pub. No.: US 2019/0137405 A1
(43) Pub. Date: May 9, 2019

(54) SYSTEM FOR MONITORING AIR QUALITY IN AN ENCLOSED ENVIRONMENT

(71) Applicant: ETHERA, Crolles (FR)

(72) Inventors: Sylvain COLOMB, Grenoble (FR); Farhad ABEDINI, Crolles (FR); Séverine MARGERIDON-THERMET, Le Versoud (FR)

(21) Appl. No.: 16/093,008

(22) PCT Filed: Apr. 14, 2017
(86) PCT No.: PCT/FR2017/050907

§ 371 Date: Oct. 11, 2018

(30) Foreign Application Priority Data
Apr. 15, 2016 (FR) 1653336

(51) Int. Cl. G01N 21/78; G01N 31/22; G01N 21/29

(52) U.S. Cl. CPC G01N 21/783; G01N 21/293; G01N 31/224

(57) ABSTRACT

In the field of monitoring air quality, and more specifically, the field of identification of the presence of gaseous chemical pollutants such as volatile organic compounds, in an enclosed environment, there is disclosed a system including: a substrate; a gaseous chemical pollutant sensor; and at least one colorimetric marker of a predetermined colour situated on the substrate.

### FIELD OF THE INVENTION

The present invention relates to the field of monitoring air quality. More specifically, the invention concerns the identification of the presence of gaseous chemical pollutants such as volatile organic compounds, in an enclosed environment, and the determination of the concentration thereof.

### STATE OF THE RELATED ART

Volatile organic compounds are found in gaseous form in the atmosphere. They constitute a very broad family of substances and include for example benzene, acetone, perchloroethylene, or aldehydes. The volatility of these substances gives same the ability to propagate more or less at a distance from the emission location thereof, thereby giving rise to direct and indirect impacts on the environment thereof.

In particular, aldehydes such as formaldehyde count among the most plentiful household chemical pollutants. The sources thereof are extremely numerous. The main emission sources of aldehydes are found inside homes and are very diverse: resins and adhesives used for manufacturing pressed woods, particle boards and plywoods; urea-formol insulating foams used as a heat insulator in walls and partitions; textile coverings, wallpapers, paints, leathers, etc. In view of the harmful effects of such chemical pollutants on public health, it would appear to be necessary to analyse the ambient air of residential buildings, and analyse the harmfulness thereof.

A number of well-known methods already exist for determining the formaldehyde saturation status of a room:

1. liquid chromatography methods;

2. colorimetric indicator tubes;

3. electrochemical cells;

4. colorimetric methods associated with optical readers.

Liquid chromatography methods require a laboratory analysis step and complex equipment. Consequently, they are time-consuming and costly.

Colorimetric indicator tubes prove to be unsuitable for household use: they have an excessively high detection threshold for applications in an enclosed environment such as a room.

Electrochemical cells are also non-selective and unsuitable: they have a detection threshold greater than the exposure limit value, considered to be polluting, in dwelling houses.

Colorimetric methods involve, after change of colour of a sensor, a measurement by an analyser or a colorimetric indicator. These techniques may be costly and inconvenient to use.

By way of example, the patent application WO 2015/009792 describes a colorimetric system for measuring and detecting carbon dioxide comprising a colorimetric indicator changing colour according to the carbon dioxide concentration. This system comprises a light source and at least one photodiode suitable for detecting the light reflected by the colorimetric indicator. The document US 2006/0008919 also discloses a detector of the presence of a target gas by means of a colorimetric indicator changing colour in the presence of said target gas. The detector comprises a light source and three colour sensors: red, green and blue configured to receive the light reflected by the colorimetric indicator. All these detectors require a calibrated light source so as to accurately detect the change of colour of the sensor. Such a light source is costly and requires regular maintenance.

As such, the methods according to the prior art are:
either unsuitable for measurements in enclosed environments;
or require equipment or a protocol that is time-consuming and costly.

The user seeking reliable and easy-to-use information, on the presence of absence of a harmful quantity of formaldehyde in an enclosed environment, currently lacks a suitable solution equally well for household use and industrial use, and which offers simple solutions adapted to the situation.

### SUMMARY

The present invention provides a system for identifying the presence of at least one gaseous chemical pollutant devoid of light source. The system according to the invention functions simply in ambient light.

In particular, the present invention relates to a system for identifying the presence of at least one gaseous chemical pollutant, preferably a volatile organic compound, in an enclosed environment, said system comprising:
a substrate;
a gaseous chemical pollutant sensor rendered rigidly connected to the substrate; said sensor changing colour according to the gaseous chemical pollutant concentration and the exposure time;
at least one colorimetric marker of a predetermined colour situated on the substrate.

According to one embodiment, at least one colorimetric marker is of a colour corresponding to the colour of the sensor in the presence of at least one gaseous chemical pollutant, preferably in the presence of a volatile organic compound.

According to one embodiment, at least one colorimetric marker is white in colour, black in colour and/or grey in colour. According to one embodiment, the system further comprises at least one bar-code, preferably situated on the substrate.

According to one embodiment, the substrate is parallelepipedal in shape, preferentially a rectangular parallelepiped.

According to one embodiment, the system comprises a moisture and/or temperature detector, preferably situated on the substrate.

According to one embodiment, the system does not comprise a light source. According to one embodiment, the substrate does not emit gaseous chemical pollutants.

According to one embodiment, the system further comprises optical recording means suitable for obtaining an image of the sensor or of the assembly formed by the sensor and the substrate thereof.

According to one embodiment, the system further comprises a mobile application or an electronic chip. According to one embodiment, the mobile application or the electronic chip comprises at least one database, suitable for use for determining the colour of the sensor and for determining the concentration of the gaseous chemical pollutant in the enclosed environment in question. According to one embodiment, the system further comprises at least one display or transmission means.

As such, the present invention also relates to a system for identifying the presence of at least one gaseous chemical pollutant, preferably a volatile organic compound, in an enclosed environment, said system comprising:
a substrate not emitting gaseous chemical pollutants;
a gaseous chemical pollutant sensor rendered rigidly connected to the substrate; said sensor changing colour according to the gaseous chemical pollutant concentration and the exposure time;
at least one colorimetric marker corresponding to the range of wavelengths absorbed by the sensor;
optionally, a moisture detector;
a mobile application or an electronic chip;
an optical recording means suitable for obtaining an image of the sensor or of the assembly formed by the sensor and the substrate thereof, said optical recording means being connected to the mobile application or to the electronic chip;
at least one database, suitable for use for determining the colour of the sensor and for determining the concentration of the gaseous chemical pollutant in the enclosed environment in question; said at least one database being connected to the mobile application or to the electronic chip; and
at least one display or transmission means connected to the mobile application or to the electronic chip.

According to one embodiment, the gaseous chemical pollutant is a volatile organic compound (VOC), preferably an aldehyde; more preferentially formaldehyde.

According to one embodiment, the sensor comprises a nanoporous specific absorbent material functionalised with at least one probe molecule capable of reacting in the presence of the gaseous chemical pollutant; preferably capable of reacting in the presence of a volatile organic compound.

According to one embodiment, the probe molecule is chosen among enaminones and β-diketone/amine pairs, imines and hydrazines, or salts derived from these compounds.

According to one embodiment, the absorbent material is a compound obtained by a sol-gel process; preferably, the absorbent material is parallelepipedal in shape.

The present invention further relates to a process for determining a concentration level of a gaseous chemical pollutant, preferably a volatile organic compound, in an enclosed environment, implementing a system according to the invention comprising the following steps:

a. analysing a first optical recording of the substrate comprising the sensor;

b. analysing a second optical recording of the same substrate comprising the sensor on expiration of a time “t”;

c. comparing between the first and the second optical recording;

d. computing a colorimetric distance;

e. analysing said colorimetric distance with reference to a database and determining the concentration of the gaseous chemical pollutant in the enclosed environment; and optionally

f. displaying or transmitting the concentration of the gaseous chemical pollutant in the enclosed environment.

The present invention further relates to a process for determining a concentration level of a gaseous chemical pollutant, preferably a volatile organic compound, in an enclosed environment, implementing a system according to the invention, comprising a mobile application or an electronic chip which:

a. analyses a first optical recording of the substrate comprising the sensor;

b. analyses a second optical recording of the same substrate comprising the sensor on expiration of a time “t”;

c. compares the first and the second optical recording;

d. computes a colorimetric distance;

e. analyses said colorimetric distance with reference to a database and determines the concentration of the gaseous chemical pollutant in the enclosed environment; and

f. displays or transmits the concentration of the gaseous chemical pollutant in the enclosed environment.

According to one embodiment, the steps for analysing a first optical recording of the substrate comprising the sensor and analysing a second optical recording of the same substrate comprising the sensor on expiration of a time “t” comprise a calibration step, preferably a step for setting the white balance, contrast and/or colour quality of the colorimetric marker.

The present invention also relates to a method for using the system according to the invention, with a view to determining the concentration of a gaseous chemical pollutant, preferably a volatile organic compound, in an enclosed environment, comprising the following steps:

a. providing the substrate comprising the sensor and, if applicable, the moisture detector;

b. placing the substrate comprising the sensor in the enclosed environment to be measured;

c. carrying out a first optical recording of the substrate comprising the sensor;

d. carrying out a second optical recording of the substrate comprising the sensor, on expiration of a time “t”;

e. determining the concentration level of the gaseous chemical pollutant according to the process according to the invention.

The present invention further relates to a method for using the system according to the invention, with a view to determining the concentration of a gaseous chemical pollutant, preferably a volatile organic compound, in an enclosed environment, comprising the following steps:

a. providing the substrate comprising the sensor and, if applicable, the moisture detector;

b. providing the mobile application or the electronic chip;

c. placing the substrate comprising the sensor in the enclosed environment to be measured;

d. carrying out a first optical recording of the substrate comprising the sensor;

e. carrying out a second optical recording of the substrate comprising the sensor, on expiration of a time “t”;

f. determining the concentration level of the gaseous chemical pollutant according to the process according to the invention.

The present invention also relates to a packaging comprising at least one system according to the invention, said packaging being impervious to moisture, light and/or gases.

The present invention also relates to an onboard system comprising a device, such as a ventilation or air purification device, wherein is rigidly mounted at least one system according to the invention.

### DEFINITIONS

In the present invention, the terms hereinafter are defined as follows:
“Nomogram”: calculation chart suitable for giving directly the concentration of gaseous chemical pollutants, such as VOCs, of an enclosed environment on the basis of an optically recorded colour, or a difference between two optically recorded colours.
“Aldehyde”: chemical compound having at least one —CO—H group.
“Alcohol”: chemical compound having at least one —OH group.
“Mobile application”: application software; standalone program designed to be downloaded and run on a mobile terminal, such as a smartphone or a touch tablet.
The “white balance” is a calibration step for adapting the dominant colour in ambient light.
The “contrast” measures the range of brightness of an image.
“Bar-code”: according to the present invention, the term “bar-code” includes one-dimensional bar-codes (1D) and two-dimensional bar-codes (2D, also known as “square bar-codes”). According to one embodiment, the square bar-codes are chosen among the codes of the “QR code” (abbreviation of “Quick Response”) type or “Datamatrix” type. According to one embodiment, the “Datamatrix” type code is a “Flash code”. Square bar-codes are made up of black modules arranged on a square with a white background. The arrangement of these points defines the information contained by the code. The content of square bar-codes may be decoded rapidly after having been read by a suitable bar-code reader, such as those contained in mobile terminals, smartphone type mobile telephones, or tablets.
“Colorimetry”: method for analysing coloured samples.
“Volatile Organic Compound” or “VOC”: any organic compound, excluding methane, having a vapour pressure greater than or equal to 0.01 kPa at a temperature of 293.15 K (20° C.) or having a corresponding volatility under particular conditions of use (pressure and temperature). VOCs particularly include aldehydes such as formaldehyde; hydrocarbons such as ethane, propane, butane, benzene; alcohols such as ethanol; acetone; or perchloroethylene. According to the present invention, the VOCs may be of natural origin or originate from human activities.
“Pantone colour”: colour from the Pantone colour chart, also known as the Pantone colour system, which includes eight hundred different hues.
“Enclosed environment”: volume delimited by walls creating a physical barrier between the external air and the air contained in the volume, and wherein the external air is not circulating. In particular, a room, a warehouse, an office, a bedroom or more generally a closed area, wherein the external air is not circulating, may be defined as an enclosed environment.
“Colorimetric space” or “Colour space”: representation of colours in a colour synthesis system in the form of triplets. Each light colour must thus be characterised by a point in a three-dimensional space.
“Formaldehyde”: organic compound having the formula HCHO.
“Probe molecule”: any organic chemical compound bearing a reactive function suitable for reacting with a gaseous chemical pollutant and resulting in at least one modification of the physicochemical properties, detectable by colorimetry. According to one preferred embodiment, the probe molecule is particularly suitable for reacting with an aldehyde; preferably, with formaldehyde.
“Concentration level”: concentration range at which, according to the limit values thereof, reference is made using a generic term such as “low”, “normal” or “high”.
“Rigidly connected”: assembled, linked, attached in a non-removable manner without voluntary intervention.
“Spectrophotometer”: apparatus for measuring the absorbance of a solution at a given wavelength or over a given region of the spectrum set according to the substance for which it is sought to ascertain the concentration.
“Zone”: part of a spatially delimited area.

### DETAILED DESCRIPTION

The present invention proposes a novel solution, suitable for easy use on the measurement site, for monitoring air quality, identifying the presence of gaseous chemical pollutants; in particular, of volatile organic compounds, or managing pollution caused by this/these pollutant(s), in an enclosed environment.

The present invention concerns various gaseous chemical pollutants, particularly volatile organic compounds; preferably, formaldehyde.

In a first aspect, the invention relates to a system for identifying, in an enclosed environment, the presence of at least one gaseous chemical pollutant and if applicable, managing pollution caused by this pollutant, which comprises:
a substrate;
a gaseous chemical pollutant sensor rendered rigidly connected to the substrate; said sensor changing colour according to the gaseous chemical pollutant concentration and the exposure time;
at least one colorimetric marker of a predetermined colour situated on the substrate.

According to one preferred embodiment, the invention relates to a system for identifying, in an enclosed environment, the presence of at least one volatile organic compound (VOC) and if applicable, managing pollution caused by said VOC, which comprises:
a substrate;
a gaseous chemical pollutant sensor rendered rigidly connected to the substrate; said sensor changing colour according to the VOC concentration and the exposure time;
at least one colorimetric marker of a predetermined colour situated on the substrate.

According to one embodiment, the VOC is an aldehyde; preferably, formaldehyde.

According to one embodiment, the system does not comprise a light source. The lack of light source makes it possible advantageously to provide a particularly simple system for identifying the presence of at least one gaseous chemical pollutant, not requiring maintenance.

So as to do away with the need for a light source, the system according to the present invention comprises at least one colorimetric marker of a predetermined colour situated on the substrate. Said at least one colorimetric marker is suitable for carrying out retrospective calibration, for example in a mobile application or an electronic chip.

According to one embodiment, the system according to the invention does not comprise a separate colorimeter.

According to one embodiment, the system according to invention does not comprise an external colorimeter.

According to one embodiment, the system according to the invention does not comprise a separate spectrophotometer.

According to one embodiment, the sensor is suitable for trapping a gaseous chemical pollutant. According to one preferred embodiment, the sensor is suitable for trapping a volatile organic compound; preferably, an aldehyde; more preferentially, formaldehyde. Advantageously, the sensor comprises a porous absorbent material capable of trapping the chemical pollutant both on the outer surface and inside the pores of the material. As such, the sensor has an enhanced and reproducible detection sensitivity with respect to the gaseous chemical pollutants.

According to one embodiment, the sensor comprises a specific absorbent material. According to one embodiment, the sensor comprises a porous absorbent material. According to one embodiment, the sensor comprises a nanoporous absorbent material. According to one embodiment, the sensor consists of a porous, preferably, nanoporous, absorbent material.

According to one embodiment, the porous absorbent material is a material obtained by a sol-gel process. According to one embodiment, the porous absorbent material is obtained according to one of the synthesis processes described in FR 2 890 745.

According to one embodiment, the porous absorbent material is functionalised with at least one probe molecule capable of reacting in the presence of a gaseous chemical pollutant; preferably, with a volatile organic compound (VOC); more preferentially, with an aldehyde; more preferentially, with formaldehyde.

According to one embodiment, the probe molecule reacts specifically with a gaseous chemical pollutant; preferably, with a volatile organic compound (VOC); more preferentially, with an aldehyde; more preferentially, with formaldehyde.

According to one embodiment, the absorbent material is manufactured by a sol-gel process.

According to one embodiment, the absorbent material is parallelepipedal in shape.

According to one embodiment, the absorbent material comprises a nanoporous specific absorbent material functionalised with at least one probe molecule which is capable of reacting with an aldehyde function. According to one embodiment, the probe molecule is chosen among enaminomes, enaminones and β-diketone/amine pairs, imines and hydrazines, or salts derived from these compounds. According to one embodiment, the volatile organic compound is formaldehyde.

Advantageously, the absorbent material changes colour according to the concentration of gaseous chemical pollutant. As such, when the sensor according to the invention comes into contact with a gaseous chemical pollutant, the sensor changes colour and absorbs a light wavelength wherein the intensity is proportional to the concentration of pollutant specifically absorbed by said sensor over time. In particular, when the sensor is placed in contact with aldehyde such as formaldehyde, the sensor absorbs the ambient light in given wavelength range and reflects in a wavelength range corresponding to yellow, and the intensity is dependent on the concentration of aldehyde absorbed and the exposure time.

The sensor is placed or attached on a substrate, and is preferably rendered rigidly connected by any suitable means. According to one embodiment, the sensor is attached to the substrate by bonding, with an adhesive not releasing gaseous chemical pollutants; preferably, not releasing VOCs; such as for example, a cyanhydric adhesive.

In a first embodiment, the substrate is rigid. In a second embodiment, the substrate is flexible.

According to one embodiment, the substrate is not sensitive to moisture.

According to one embodiment, the substrate does not emit gaseous chemical pollutants.

According to one embodiment, the substrate does not emit VOCs.

According to one embodiment, the substrate is magnetic.

According to one embodiment, the substrate is an adhesive plane substrate, on one or the other of the faces thereof.

According to one embodiment, the substrate is made of paper, plastic-coated paper, cardboard, polymer.

According to one embodiment, the substrate comprises at least one identification code, particularly a bar-code; preferably a square bar-code; more preferentially a QR code. This identification code, particularly this bar-code; preferably this square bar-code, more preferentially this QR code is suitable for identifying the substrate on a unit basis. According to one embodiment, the substrate comprises 2 identification codes, particularly 2 bar-codes; preferably 2 square bar-codes; more preferentially 2 QR codes. The first identification code makes it possible to identify the substrate; and the second identification code makes it possible to download the mobile application associated with the substrate and with the sensor.

According to one embodiment, the substrate is of a uniform colour.

According to one embodiment, the substrate of a light and constant colour.

According to one embodiment, the substrate is a card.

According to one embodiment, the substrate is a card configured to be exposed to gaseous chemical pollutants, particularly to VOCs. The term card denotes a flat substrate, preferentially parallelepipedal in shape, more preferentially a rectangular parallelepiped.

According to one embodiment, the at least one colorimetric marker is situated on the substrate.

According to one embodiment, the substrate forms a colorimetric space, wherein the sensor is situated. In this embodiment, the substrate has 1, 2, 3, 4, 5, 6, 7, 8, 9, or 10 zones, at least one whereof is coloured. The colouring of at least one zone makes it possible to create a coloured control to assess the change in the colour of the sensor. Advantageously, at least one zone has a geometric shape. The geometric shape may be a circle, a square, a triangle, a rectangle. According to one embodiment, all the zones are of an identical geometric shape. In a further embodiment, at least two zones have different geometric shapes.

According to one embodiment, at least one colorimetric marker is of a colour corresponding to the colour of the sensor in the presence of at least one gaseous chemical pollutant, preferably in the presence of a volatile organic compound. The term corresponding denotes equal, similar or substantially similar.

According to one embodiment, at least one colorimetric marker is white in colour or of a colour substantially similar to the colour white. According to one embodiment, at least one colorimetric marker is black in colour or of a colour substantially similar to the colour black. According to one embodiment, at least one colorimetric marker is grey in colour or of a colour substantially similar to the colour grey.

According to one embodiment, the substrate comprises at least two zones:
at least one control zone;
a zone whereon the sensor is placed or secured.

According to one embodiment, the control zone is of a colour corresponding to the colour of the sensor in the presence of at least one gaseous chemical pollutant, preferably in the presence of a volatile organic compound.

According to one embodiment, the substrate comprises at least three zones:
at least one white or black coloured zone;
at least one control zone;
a zone whereon the sensor is placed or secured.

According to one embodiment, the substrate contains five zones:
a white coloured zone;
a black coloured zone;
a neutral grey coloured zone, preferably Pantone 424C grey;
a yellow coloured control zone, preferably Pantone 108C yellow; and
a zone whereon the sensor is placed or secured.

According to one embodiment, the colours of the zones of the substrate are colours referenced and/or calibrated in colour charts. According to one embodiment, the colours of the zones of the substrate are Pantone colours. According to one embodiment, the colours of the zones of the substrate are RAL colours.

According to one embodiment, the invention comprises means for optical recording of the sensor, suitable for acquiring a recording, for example an image or a photograph of the sensor or of the assembly formed by the sensor and the substrate thereof. According to one embodiment, the optical recording means is a camera. According to one embodiment, the optical recording means is a still camera. According to one embodiment, the optical recording means is a sensor comprising at least one photodiode, preferably a CMOS (“Complementary Metal-Oxide-Semiconductor”) type sensor. According to one embodiment, the optical recording means is included in a personal computer, which is preferably an IOS or Android type mobile terminal (so-called “smartphone” or touch tablet).

This optical recording means makes it possible to acquire a recording of the whole sensor or of the assembly formed by the sensor and the substrate thereof. As such, according to the present invention, the data are obtained on a much larger surface area than in the systems according to the prior art analysing the change of colour at a given point.

According to the present invention, the optical recording means is not a calibrated optical recording means requiring regular maintenance. On the contrary, the optical recording means according to the present invention may be a CMOS type sensor well-known per se to those skilled in the art.

According to one embodiment, the system comprises a mobile application or an electronic chip. So as to calibrate each image of the sensor or of the assembly formed by the sensor and the substrate thereof, the predetermined colour of each marker is saved in the mobile application or the electronic chip and compared to the image of the same colorimetric marker taken by the optical recording means.

A calibration or standardisation step is then carried out. In particular, a step for setting the white balance, contrast and/or colour quality of the at least one colorimetric marker.

According to one embodiment, the mobile application or the electronic chip sets the white balance using the grey colorimetric marker.

According to one embodiment, the mobile application or the electronic chip sets the contrast using the black and white colorimetric markers.

According to one embodiment, the mobile application or the electronic chip checks the colour quality using the colorimetric marker corresponding to the colour of the sensor in the presence of at least one gaseous chemical pollutant. In particular by computing a colorimetric distance between the colour of the colorimetric marker as recorded with the optical recording means and the predetermined colour of the colorimetric marker corresponding to the colour of the sensor in the presence of at least one gaseous chemical pollutant.

According to one embodiment, the mobile application or the electronic chip comprises at least one database, suitable for use for determining the colour of the sensor and for determining the concentration of the gaseous chemical pollutant in the enclosed environment in question. According to one embodiment, the mobile application or the electronic chip analyses a first recording made using the optical recorder and classifies it as a reference recording. According to one embodiment, the mobile application or the electronic chip comprises an expert system for analysing the recording. According to one embodiment, the mobile application or the electronic chip displays the recording and a recording validation request, or a request to repeat a recording. After a time t, the mobile application or the electronic chip sends a notification to take a second photo and specify moisture data of the enclosed environment. In the embodiment of the invention where the system comprises a moisture detector, the mobile application preferably comprises a system for analysing the moisture detected by the moisture detector.

According to one embodiment, the mobile application or the electronic chip comprises a system for analysing the volume of the enclosed environment wherein the sensor is placed, after having been unpacked.

According to one embodiment, the mobile application or the electronic chip comprises a system for analysing environmental conditions applying to the unpacked sensor (particularly season, weather, presence or absence of heating or air conditioning, room volume, presence or not of ventilation).

According to one embodiment, the mobile application or the electronic chip comprises a system for segregating or sorting optical images recorded by the optical recording means, and a means for communicating with the user, to request the user if required to record an optical image again.

According to one embodiment, the mobile application or the electronic chip is suitable for comparing two optical recordings which have been submitted thereto successively for a given enclosed environment, and for evaluating the colour differential or colorimetric difference of the sensor between the two optical images.

The method for comparing two colours is well-known to those skilled in the art. Indeed, this requires computation which makes it possible to find the difference between two colours involving two points, in a three-dimensional space: the distance between two points (also known as the colorimetric distance) is the difference in colour. The three dimensions of the space are replaced by the three primary colours: red, green, blue. All colours are a combination of these three primary colours.

According to one embodiment, the method for comparing two colours is chosen among the methods having by way of reference CIE Lab or HSV. According to one preferred embodiment, the method for comparing two colours using the HSV (Hue Saturation Value) reference.

The HSV reference is a system for managing colours based on the perception of the colours and makes use of a 3D space wherein the dimensions are defined by the hue, the saturation and the value. The HSV reference is also known as the HSB (Hue Saturation Brightness) reference.

In the CIE Lab reference, the computation per se makes use of the CIE Lab three-dimensional space, formed by the axis L (black-white), the axis a (green-magenta) and the axis b (yellow-blue), which corresponds to the difference in colour perception. The greater the distance, the greater the difference in colour. On the other hand, the lower the distance, the less the difference between two colour hues. It is thus merely a case of replacing the CIE Lab coordinates thereof in the following algebraic equation:

ΔE=\sqrt{(ΔL)²+(Δa)²+(Δb)²}

According to one embodiment, the application is connected with an onboard server comprising the database or with a remote server comprising the database.

According to one embodiment, the mobile application comprises software for determining the concentration of gaseous chemical pollutant, in particular of volatile organic compound, in the sensor whereof it has analysed an optical image, using information contained in a database.

According to one embodiment, the mobile application computes the concentration of gaseous chemical pollutant; optionally, the mobile application displays an evaluation of the concentration of volatile organic compound(s). According to one embodiment, the mobile application displays one of the following three items: (1) air with low pollution; for example, for formaldehyde, less than 30 micrograms per cubic metre; (2) moderately polluted air; for example, for formaldehyde, from 30 to 100 micrograms per cubic metre; (3) at-risk air; for example, for formaldehyde, more than 100 micrograms per cubic metre.

According to one embodiment, the database contains nomograms, suitable for identifying the exact colour of the sensor, and inferring from this colour the concentration of the gaseous chemical pollutant, in particular of the volatile organic compound, present in the room.

According to one embodiment, the mobile application or the electronic chip is suitable for carrying out the processing of the data, particularly of the image, obtained using the optical recording means and communicating with the database.

According to one embodiment, the system comprises at least one display or transmission means connected to the mobile application or to the electronic chip.

According to one embodiment, the connection between the mobile application or the electronic chip and:
the recording means;
the at least one database; and/or
the at least one display or transmission means is a wireless connection.

According to one embodiment, the connection between the mobile application or the electronic chip and:
the recording means;
the at least one database; and/or
the at least one display or transmission means is a wired connection.

The presence and the arrangement of the different zones, including the zone comprising the QR code, have the function of enabling the correction of the geometry of the image capture. Indeed, during image capture, an angle may be formed between the optical recording means and the card or the substrate involving a slight modification of the dimensions of the card or the substrate.

According to one embodiment, the substrate comprising the gaseous chemical pollutant sensor, at least one colorimetric marker and, optionally, a bar-code and a moisture detector, is packaged in wrapping. According to one embodiment, the wrapping is impervious to moisture, light and/or gases.

According to one embodiment, the packaging comprises at least one system as described above, said packaging being impervious to moisture, light and/or gases. This packaging makes it possible to prevent the degradation or pollution of the system according to the invention by moisture, light and/or gases prior to the use thereof.

According to one embodiment, the substrate is packaged in nitrogen.

According to one embodiment, the wrapping comprises a package insert (instructions for use).

According to a first embodiment, the wrapping comprises a moisture detector. According to a second embodiment, the moisture detector is placed in separate wrapping. According to one embodiment, the moisture detector is placed on the substrate, in particular on the card.

According to one embodiment, the substrate comprises at least two sensors, preferably 3, 4, 5, 6 sensors, each sensor being packaged in individual wrapping, the 2, 3, 4, 5, 6 individual wrappings being placed in a case.

According to one embodiment, the wrapping or packaging comprises a plurality of substrates, said substrates each being packaged separately.

According to one embodiment, the moisture sensor comprises at least three zones for reaction with the ambient air. These zones enable a qualitative determination of the moisture of the room. Each zone corresponds to a specific moisture value.

According to one embodiment, the moisture sensor comprises 3, 4, 5, 6, 7, 8, 9, 10 zones for determining the moisture. Preferably, the moisture sensor is of the type marketed by 3M under the name Humidity indicator card.

According to one embodiment of the invention, the substrate comprising the sensor is embedded in a device, particularly in a reader, in a ventilation device or an air purification device.

According to one embodiment, the substrate comprises at least one electronic component, in particularly an integrated circuit also known as an electronic chip. According to one embodiment, the substrate comprises a digital integrated circuit, preferably a digital signal microprocessor.

According to one embodiment, the substrate comprises a chip and a Red Green Blue sensor.

According to one embodiment, the onboard system according to the invention comprises a light source, for example a white LED, illuminating the sensor, and an optical recording means of the colour of the sensor. According to one embodiment, the optical recording means is a Red Green Blue sensor.

According to one embodiment, the integrated circuit carries out all the functionalities cited above for the mobile application.

According to one embodiment, the onboard system comprises a sensor according to the invention, a light source and a Red Green Blue sensor. According to one embodiment, the onboard system comprises a protective film between the light source and the Red Green Blue sensor to prevent direct exposure. According to one embodiment, the onboard system comprises a protective mask against interference.

According to one embodiment, the system according to the invention further comprises a database of recommendations, which are linked with the identified colour of the sensor, and sent by the mobile application to the user. These recommendations particularly relate to the ventilation of the enclosed environment, eradication of a source of gaseous chemical pollutants such as VOCs or the use of a purifier. These recommendations may also be presented in the form of links to websites presenting products the quality whereof has been certified.

According to one embodiment, the system according to the invention further comprises a display and transmission means connected to the mobile application or to the electronic chip. According to one embodiment, the display means is configured to display the concentration of gaseous chemical pollutant and/or recommendations retrieved from the recommendations database. According to one embodiment, the transmission means is configured to transmit the estimate concentration value of the gaseous chemical pollutant, particularly of the VOC.

In a second aspect, the invention also relates to a process for determining the concentration of a gaseous chemical pollutant; preferably, a volatile organic compound, in an enclosed environment, implementing the system described above comprising a mobile application or an electronic chip which:

a. analyses a first optical recording of the substrate comprising the sensor;

b. analyses a second optical recording of the same substrate comprising the sensor on expiration of a time “t”;

c. compares the first and the second optical recording;

d. computes a colorimetric distance;

e. analyses said colorimetric distance with reference to a database and determines the concentration of the gaseous chemical pollutant in the enclosed environment; and

f. displays or transmits the concentration of the gaseous chemical pollutant in the enclosed environment.

According to one embodiment, the steps for analysing a first optical recording of the substrate comprising the sensor and analysing a second optical recording of the same substrate comprising the sensor on expiration of a time “t” comprise a calibration step, preferably a step for setting the white balance, contrast and/or colour quality.

According to one embodiment, the process according to the invention further comprises the step for assessing the quality of the image analysed and, may if applicable require a further optical recording.

According to one embodiment, the process according to the invention further comprises the step for accounting for parameters liable to influence the results, for example, and non-restrictively, the temperature of the enclosed environment, the environmental pressure, the presence and age of the fixtures and fittings, the volume of the enclosed environment, the presence of ventilation, heating or air-conditioning, the number of doors or windows.

The invention has numerous advantages, of which that of enabling a rapid, reliable and very energy-efficient test.

The invention also relates to a method for using the system according to the invention, with a view to determining the concentration of a gaseous chemical pollutant, preferably a volatile organic compound, in an enclosed environment, comprising the following steps:

a. providing the substrate comprising the sensor and, if applicable, the moisture detector;

b. providing the mobile application or the electronic chip;

c. placing the substrate comprising the sensor in the enclosed environment to be measured;

d. carrying out a first optical recording of the substrate comprising the sensor;

e. carrying out a second optical recording of the substrate comprising the sensor, on expiration of a time “t”;

f. determining the concentration level of the gaseous chemical pollutant according to the process described above.

According to one embodiment, the first recording is made between 5 and 90 minutes after unpacking the substrate, in particular the card. According to one embodiment, the application is provided by downloading using bar-codes, preferentially using the QR code, provided on the packaging or the package insert. According to one embodiment, the code situated on the substrate serves to identify the sensor on a unit basis.

According to one embodiment, the method of use according to the invention further comprises the preliminary step, before opening the packaging wherein the substrate is, of preparing the enclosed environment to be measured and the optical recording conditions.

According to one embodiment, the method of use according to the invention further comprises the step for determining the moisture of the enclosed environment. Advantageously, the optical recording is performed at a time when there is satisfactory brightness in the enclosed environment. Advantageously, the substrate is placed at the level of a light source, for example a window, preferentially with no direct exposure to sunlight. According to one embodiment, the time “t” ranges from 2 hrs to 48 hrs. Preferably, the time “t” is equal to 24 hrs.

### BRIEF DESCRIPTION OF THE FIGURES

FIG. 1 is a top view of the system according to the invention.

FIG. 2 illustrates the onboard sensor according to the invention.

### LISTS OF REFERENCES

1—Substrate;

2—Sensor;

3—Central square;

4—Rectangle;

5A, 5B, 5C, 5D, 5E—Colorimetric marker square;

6—QR Code;

7—White LED;

8—Red Green Blue sensor;

9—Protective film;

10—White surface;

11—Protective mask against interferences.

### EXAMPLES

The present invention will be understood more clearly on reading the following examples which illustrate the invention in a non-limiting manner.

### Example 1: Target Card

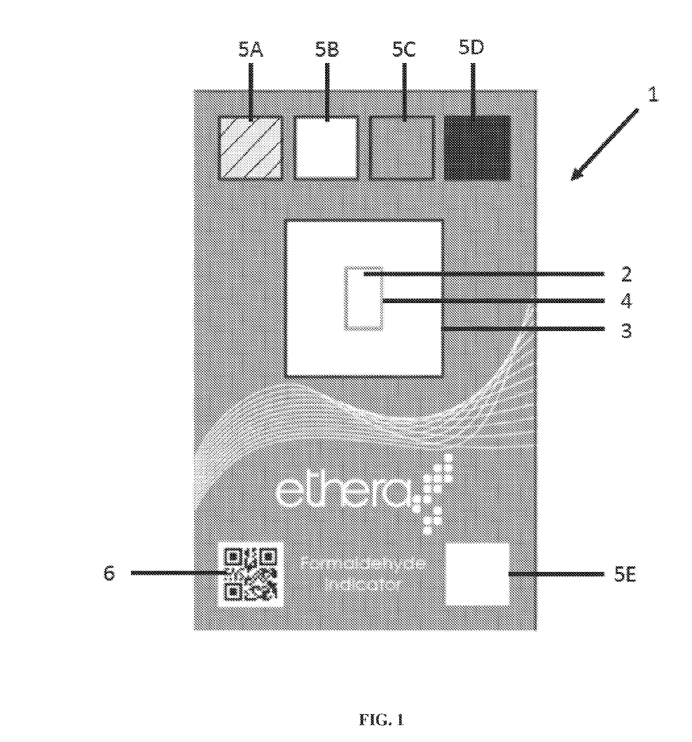

FIG. 1 shows an embodiment of the invention wherein a substrate 1 bears a sensor 2, which is a functionalised nanoporous specific absorbent material. The substrate 1 is a card type substrate. The sensor 2 is positioned on this substrate 1 in a central square 3 comprising at the centre thereof a rectangle 4 delimiting a zone intended to receive the sensor 2. The sensor 2 is secured by bonding, with an adhesive not releasing VOCs, for example a cyanhydric adhesive.

The substrate further comprises four square-shaped colorimetric markers 5A, 5B, 5C, 5D of different colours: for example, a yellow square (represented by the hatched square), a white square, a grey square and a black square, the order of positioning whereof is of no importance.

The sensor 2 is a formaldehyde sensor which changes in a range of yellows and at least one of the squares 5A, 5B, 5C, 5D is of Pantone yellow colour for the purposes of evaluating the change in the colour of the sensor with an unchanging control in the colour range. The white, grey and black squares serve to adjust the real colour temperature i.e. recalibrate the colour to remove differences due to the optical recorder or to the lighting.

The substrate 1 further comprises a QR code 6 which serves to identify the sensor on a unit basis, and particularly to identify the sensor in the database.

Advantageously, the squares 5A, 5B, 5C, 5D and the QR code 6 are positioned on the substrate 1 such that they make it possible to make a correction of the geometry of the image capture, if required. Indeed, during image capture, an angle may be formed between the optical recording means and the card involving a slight modification of the dimensions of the card.

Advantageously, the substrate further comprises one or a plurality of further squares 5E which are positioned with respect to the squares 5A, 5B, 5C, 5D and to the QR code 6 such that they make it possible to evaluate a possible inclination during image capture.

### Example 2: Example of Use of the Card

The user purchases a card, which is supplied in nitrogen wrapping. Instructions for use are supplied with the card. In the instructions, it is specified that the card must be used in relation with a smartphone and a moisture detector, and the user is requested to download the mobile application. The instructions specify to the user that a photo must be taken within a few minutes following the exposure of the card to ambient air, preferably from 5 to 90 minutes after opening the packaging. The image capture conditions are specified in the instructions. To optimise image capture, it is advisable to choose a time of the day when there is satisfactory brightness for the photo, and place the target next to a window without direct sunlight. It is furthermore necessary not to use a flash so as to prevent overexposure. Indeed, exposure to a flash or to a light source involve spatial inhomogeneity of the lighting.

Firstly, the user tests the moisture of the enclosed environment wherein the VOC concentration is measured. The application is set to photo mode and the user takes a photo of the target.

The application checks whether the photo is of poor quality or not, i.e. whether it is too out of focus, not straight enough, with colours that are too dark, with colours that are too light, incorrect colours. If such is the case, the application may request to repeat the capture operation of the initial photo which is a reference photo. Then, the application notifies that you will be contacted within 24 hrs to take the final photo and complete the test.

Secondly, after 24 hrs, the application requests the visible estimation on the moisture detector then, requests that a second, final photo be taken, under the same conditions as the first photo.

The application computes the pollutant on the basis of the two photos.

The application will seek to determine the parameters liable to impact the results such as the temperature of the enclosed environment, the environmental pressure, the fixtures and fittings and age, the room volume, the presence of ventilation, the number of doors, windows and among the number, those which are open.

### Example 3: Onboard System

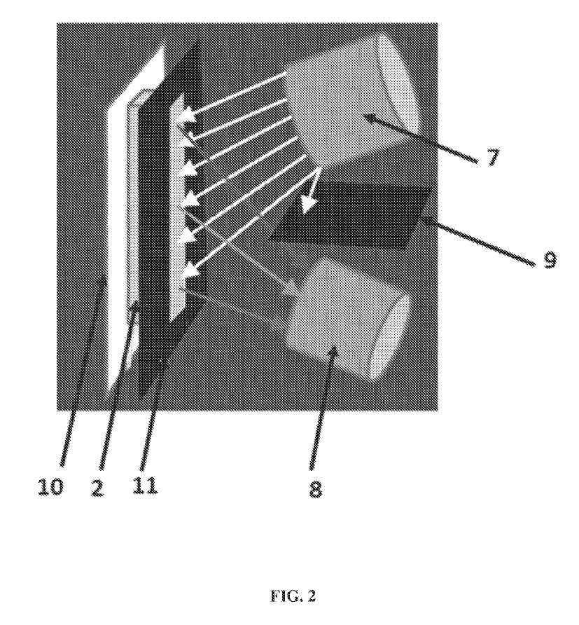

FIG. 2 illustrates an onboard system according to the invention. The onboard system comprises a device, particularly in a reader, a ventilation device or an air purification device, a substrate 1 comprising a sensor 2, a white LED 7 illuminating the sensor 2 and a Red Green Blue sensor 8 to capture the light of the sensor 2. The onboard system also comprises a protective film 9 separating the white LED 7 from the Red Green Blue sensor 8, so as to prevent direct exposure of the Red Green Blue sensor 8. The onboard system further comprises a white surface 10 to the rear of the substrate 1 and a protective mask against interferences 11.

1-49. (canceled)

50. System for identifying the presence of at least one gaseous chemical pollutant, preferably a volatile organic compound, in an enclosed environment, said system comprising:
a substrate (1);
a gaseous chemical pollutant sensor (2) rendered rigidly connected to the substrate (1); said sensor (2) changing colour according to the gaseous chemical pollutant concentration and the exposure time; and
at least one colorimetric marker (5A, 5B, 5C, 5D, 5E) of a predetermined colour situated on the substrate.

51. System according to claim 50, wherein at least one colorimetric marker (5A, 5B, 5C, 5D, 5E) is of a colour corresponding to the colour of the sensor in the presence of at least one gaseous chemical pollutant, preferably in the presence of a volatile organic compound.

52. System according to claim 50, wherein at least one colorimetric marker (5A, 5B, 5C, 5D, 5E) is white in colour.

53. System according to claim 50, wherein at least one colorimetric marker (5A, 5B, 5C, 5D, 5E) is black in colour.

54. System according to claim 50, wherein at least one colorimetric marker (5A, 5B, 5C, 5D, 5E) is grey in colour.

55. System according to claim 50, wherein the system further comprises at least one bar-code (6), preferably situated on the substrate (1).

56. System according to claim 50, wherein the substrate (1) is parallelepipedal in shape, preferentially a rectangular parallelepiped.

57. System according to claim 50, wherein the system further comprises a moisture detector, preferably situated on the substrate (1).

58. System according to claim 50, wherein the system further comprises a temperature detector, preferably situated on the substrate (1).

59. System according to claim 50, wherein the system does not comprise a light source.

60. System according to claim 50, wherein the substrate (1) does not emit gaseous chemical pollutants.

61. System according to claim 50, wherein the system further comprises a mobile application or an electronic chip.

62. System according to claim 61, wherein the mobile application or the electronic chip comprises at least one database, suitable for use for determining the colour of the sensor and for determining the concentration of the gaseous chemical pollutant in the enclosed environment in question.

63. System according to claim 50, wherein the system further comprises optical recording means suitable for obtaining an image of the sensor (2) or of the assembly formed by the sensor (2) and the substrate (1) thereof.

64. System according to claim 50, wherein the system further comprises at least one display or transmission means.

65. System according to claim 50, wherein the gaseous chemical pollutant is a volatile organic compound (VOC), preferably an aldehyde; more preferentially formaldehyde.

66. System according to claim 50, wherein the sensor (2) comprises a nanoporous specific absorbent material functionalised with at least one probe molecule capable of reacting in the presence of the gaseous chemical pollutant; preferably capable of reacting in the presence of a volatile organic compound.

67. System according to claim 66, wherein the probe molecule is chosen among enaminones and β-diketone/amine pairs, imines and hydrazines, or salts derived from these compounds.

68. System according to claim 50, wherein the sensor comprises an absorbent material obtained by a sol-gel process.

69. System according to claim 50, wherein the sensor comprises a parallelepipedal-shaped absorbent material.

70. Process for determining a concentration level of a gaseous chemical pollutant, preferably a volatile organic compound, in an enclosed environment, implementing a system according to claim 50, comprising the following steps:
a. analysing a first optical recording of the substrate comprising the sensor;
b. analysing a second optical recording of the same substrate comprising the sensor on expiration of a time “t”;
c. comparing between the first and the second optical recording;
d. computing a colorimetric distance;
e. analysing said colorimetric distance with reference to a database and determining the concentration of the gaseous chemical pollutant in the enclosed environment; and optionally
f. displaying or transmitting the concentration of the gaseous chemical pollutant in the enclosed environment.

71. Process according to claim 70, wherein the step for analysing a first optical recording of the substrate (1) comprising the sensor (2) and the step for analysing a second optical recording of the same substrate (1) comprising the sensor (2) on expiration of a time “t” comprise a calibration step according to the ambient brightness, preferably a step for setting the white balance, contrast and/or colour quality.

72. Method for using the system according to claim 50, with a view to determining the concentration of a gaseous chemical pollutant, preferably a volatile organic compound, in an enclosed environment, comprising the following steps:
a. providing the substrate (1) comprising the sensor (2) and, if applicable, the moisture detector;
b. placing the substrate (1) comprising the sensor (2) in the enclosed environment to be measured;
c. carrying out a first optical recording of the substrate (1) comprising the sensor (2);
d. carrying out a second optical recording of the substrate (1) comprising the sensor (2), on expiration of a time “t”;
e. determining the concentration level of the gaseous chemical pollutant by performing steps of:
i. analysing a first optical recording of the substrate comprising the sensor;
ii. analysing a second optical recording of the same substrate comprising the sensor on expiration of a time “t”;
iii. comparing between the first and the second optical recording;
iv. computing a colorimetric distance;
v. analysing said colorimetric distance with reference to a database and determining the concentration of the gaseous chemical pollutant in the enclosed environment; and optionally
vi. displaying or transmitting the concentration of the gaseous chemical pollutant in the enclosed environment.

73. Packaging comprising at least one system according to claim 50, said packaging being impervious to moisture, light and/or gases.

74. Onboard system comprising a device, such as a ventilation or air purification device, wherein is rigidly mounted at least one system according to claim 50.
